(19) United States
(12) Patent Application Publication
(10) Pub. No.: US 2024/0070188 A1
(43) Pub. Date: Feb. 29, 2024

(54) SYSTEM AND METHOD FOR SEARCHING MEDIA OR DATA BASED ON CONTEXTUAL WEIGHTED KEYWORDS

(71) Applicant: UNNANU, INC., Austin, TX (US)

(72) Inventor: Madhusudhan R. Basu, Austin, TX (US)

(21) Appl. No.: 18/239,500

(22) Filed: Aug. 29, 2023

Related U.S. Application Data
(60) Provisional application No. 63/401,853, filed on Aug. 29, 2022.

(51) Int. Cl. G06F 16/48; G06F 16/2457; G06F 16/435; G06F 16/438

(52) U.S. Cl. CPC G06F 16/48; G06F 16/24578; G06F 16/435; G06F 16/438

(57) ABSTRACT

System and method for searching media or data based on contextual weighted keywords are disclosed. The method includes receiving search inputs for searching the media or data and determining first contextual weighted keywords. The method includes weighing the determined first contextual weighted keywords in terms of high, low, positive, negative, factor less, and factor more than the pre-defined value. Further, the method includes analysing the stored media or data sets in a database by performing searching, mapping, scoring, matching, aligning, and grading. The method further includes fetching the stored media or data based on the results of the analysis and ranking based on both a number of times the contextual weighted keywords were used in the stored media or data and the weight of first contextual weighted keywords and rendering the ranked stored media or data to the user.

### RELATED APPLICATION

The present application claims priority to U.S. Provisional Patent Application Ser. No. 63/401,853, titled “CONTEXTUAL WEIGHTED KEYWORDS SEARCH”, filed on Aug. 29, 2022, which is fully and completely incorporated by reference herein.

### FIELD OF THE PRESENT DISCLOSURE

Embodiments of the present disclosure generally relate to the field of searching media or data sets. Embodiments of the present disclosure relate to a system and method for searching media or data based on contextual weighted keywords.

### BACKGROUND OF THE DISCLOSURE

Ever-increasing dependency on data and digital files in the modern world has led to a larger data sets and/or number of files being stored in databases across the globe. Further, the large number of stored files includes all sorts of content (such as documents, bills, photos, contacts, videos, audio, etc.) including personal, professional, travel, or the like. Due to the large number, scrolling and searching for a particular file (or, types of files) is difficult, thus, search systems are used for such searching of the particular file among the large number of stored files in the database. Typically, the conventional search systems facilitate a user to provide search inputs (for e.g., words or sentences) and perform word-to-word matching between the provided search inputs and representation or meta tags (i.e., ids, names and descriptions) of one or more files stored in the databases. Based on word-to-word matching, the conventional systems fetch one or more files having exact search inputs and rank them in terms of the highest occurrence of the search inputs for presenting to the user. However, most of the time, the representation or meta tags of the stored files are not exactly the same as the exact search inputs (for example, different sentence formations, use of prepositions, and/or connecting words), thus, the conventional systems fail to present many relevant files and have low accuracy.

Some of the known solutions partially overcome such issues of low accuracy by pre-processing the search input to remove connecting words, prepositions, and less important words to determine one or more keywords in the search inputs. Such search systems then perform word-to-word matching of the determined keywords with the content of one or more files stored in the database such that files that are not exactly the same are also presented to the user. One of these existing systems are described below:

A U.S. Pat. No. 7,398,201 B2 discloses a system and a method for enhanced data searching. The system discloses storing the files only in terms of entity tags having a type and value, such that the entity tag is a possible attribute of a sentence that does not represent a part of speech and does not represent a grammatical role. Thus, the system performs searching based on such tags to return data that does not exactly match the submitted search input but is relevant.

However, such solutions are still not accurate and miss a lot of files because of possible synonyms or contextually different words being used. For example, consider a simple scenario where a file is represented by “Picture of Eiffel Tower” and the search input is “show images of Eiffel Tower”. In such a scenario, the solutions known in the art would not present the aforementioned file to the user because of different terms i.e., ‘picture’ and ‘image’, however, it is clear that the file is highly relevant.

Some of the known solutions partially overcome such issues of non-contextual searching by performing a first pre-processing of the search input to remove connecting words, prepositions, and less important words to determine one or more keywords. Such search systems perform a second pre-processing to determine similar words, synonyms, rules, or the like. The second pre-processing allows the search systems to search for the files in the database based on the context of the search input and not the words per se, thereby, giving comparatively accurate results. One of these existing systems is described below:

A U.S. Pat. No. 8,856,096 B2 discloses extending keyword searching to syntactically and semantically annotated data. The system discloses receiving a search query and determining a plurality of matching rules including a relationship search specification string that specifies syntax for a corresponding relationship search to be executed as a search. Such relationship search specification string indicates one or more terms and associated syntactic and/or semantic information used to convey how one or more terms are to be understood during searching.

However, since all the determined keywords in the search inputs are not equally important and the conventional search systems fail to prioritize keywords against one another, the conventional search system lacks accuracy in practical use. For example, in an example of a recruitment post, “Need a Java developer with preferable experience in C++ (not essential)”, the conventional system would give equal importance to the candidates who are Java developers and C++ developers, which clearly is inaccurate and thus, the search results would include a lot of irrelevant candidates who would be proficient in C++ but may be having a little knowledge of Java.

Therefore, there is a need for an improved system and method for accurately searching relevant files from the databases to overcome the drawbacks of the prior arts.

The information disclosed in this background of the disclosure section is only for enhancement of understanding of the general background of the disclosure and should not be taken as an acknowledgement or any form of suggestion that this information forms existing information already known to a person skilled in the art.

### BRIEF SUMMARY OF THE DISCLOSURE

The disclosed subject matter provides a method and system for searching media or data (such as textual content, data sets, a document, an image, an audio, and/or a video) based on contextual weighted keywords.

For purpose of the disclosed subject matter, the terms “media” and “data” are distinguished. Media may be considered as electronic data by audio, video, document, or content either on real-time or stored. In contrast, data may be considered as electronic structure, semi-structure, or unstructured data either capture in real time or stored. For purpose of the disclosed subject matter the terms “contextual weighted keywords” and “weighted keywords” are distinguished. Contextual weighted keywords may be considered as being understood and generated as weighted by importance in light of a contextual analysis. In contrast, weighted keywords may be understood as weighted by importance without consideration for contextual analysis.

The presently disclosed subject matter further contrast between time and times. the time is treated as a point of time where actual keyword found, spoke, or felt in a spectrum of the length where time is between point A to point B. Times is treated as a quantity across different time where the number of keywords found or vice versa.

In some embodiments, the system utilizes one or more known cognitive Artificial Intelligence (AI) platforms to determine one or more contextual weighted keywords for one or more media or data stored in a database. Unlike conventional keywords which correspond to an identified word in a content, the contextual weighted keywords may be understood as one or more words having similar contextual meaning to the identified word. For example, consider a media file associated with a resume having a description: “a Java programmer working in XYZ company”. In this exemplary scenario, the keywords may be “Java programmer” and “XYZ company”, however, the contextual weighted keywords may be “Java programmer”, “programmer”, “coder”, “developer”, “software engineer”, “Java Coding”, “XYZ company”, “IT company”, “software company”, “IT service enterprise”, or the like having a subset of Java skills (J2EE, Spring, RESTful, Git, DevOps, etc.) to perform work. Further, the system weighs the determined one or more contextual weighted keywords to represent the corresponding data or media file in the database. For example, the contextual weighted keywords pertaining to the “Java programmer” may be weighed higher than the contextual weighted keywords pertaining to the “XYZ company” since an organization would be more interested in the skills rather than the organization a person is working in. However, it may be noted that the one or more contextual weighted keywords may also be utilized and may not be deleted since they are also important in some scenarios. For example, however, the contextual weighted keywords pertaining to the “XYZ company” may be less useful than the contextual weighted keywords pertaining to the “Java programmer”, they may not be deleted but only weighted lower since in some scenarios, such as where a recruiter wants to check only the employees from a particular company, these contextual weighted keywords may also play an important part. The system represents each of the media files (for example, the resumes) in the database by the corresponding contextual weighted keywords sorted by the assigned weights.

Further, for performing the search of the data or media file stored in the database, the user may give search input, such as in the form of a sentence, one or more keywords, a search string, an image, a document, an audio file, and a video file. It may be understood that if the search inputs are not in textual forms (such as an image, a document, an audio file, and/or video file), then the system may first convert the provided search inputs into the textual form, such as by Optical Character Recognition (OCR), Transcriptions, Natural Language Processing (NLP), Neural Networks (NN), Robotic Process Automation (RPA), Computer Vision (CV), Digital Assistant (DA) or the like. Once the search inputs are converted into the textual form, the system may determine one or more contextual weighted keywords from the received search inputs. Such contextual weighted keywords may be different from conventional keywords. For example, considering a job vacancy description “need a programmer for an IT company”, the keywords may be “programmer” and “IT company”, however, the contextual weighted keywords may be “programmer”, “coder”, “developer”, “software engineer”, “Java Coding”, “C++ coding”, “IT company”, “software company”, “IT service enterprise”, or the like. Further, the system weighs the determined one or more contextual weighted keywords to identify which contextual weighted keywords are more relevant. For example, the contextual weighted keywords pertaining to the “programmer” may be weighed higher than the contextual weighted keywords pertaining to the “IT company” since the skill of the person would be more important than the company the person is working in, however, the contextual keyword pertaining to the “IT company” may just be weighted lower and not removed since a person working in a Multi-National Company (MNC) may be assumed to be more skilled than a person working in a small company.

Thereafter, the system may analyze the contextual weighted keywords from the search input against the contextual weighted keywords of each of the media file in the database to identify relevant media files for the search. The system may then rank the relevant media files based on the number of times such contextual weighted keywords appear in the relevant media files while considering the weights assigned to the contextual weighted keywords. The system may then render the ranked relevant media files to the user.

In some embodiments, the system for searching media based on contextual weighted keywords is disclosed. The system includes a receiving module to receive, from a user, search inputs for searching the media. The media correspond to textual content, data sets, a document, an image, an audio, and/or a video. Further, the search inputs include textual inputs, data sets, documents, audio, videos, and/or images. In some embodiments, the system includes a contextual learning module to determine one or more first contextual weighted keywords from the received searched inputs by employing one or more cognitive Artificial Intelligence (AI) models.

In some embodiment, the system includes a keyword weighing module to weigh each of the determined one or more first contextual weighted keywords in terms of high, low, positive, negative, factor less than a pre-defined value, and/or factor more than the pre-defined value. The keyword weighing module weighs each of the determined one or more first contextual weighted keywords based on one or more pre-defined criteria. The one or more pre-defined criteria may include the relevancy of the contextual keyword with respect to context, facial expressions corresponding to the contextual keyword, acoustic characteristics corresponding to the contextual keyword, and/or user inputs.

In some embodiments, the system includes a search module to analyse one or more stored media in a database by performing searching, mapping, scoring, matching, aligning, and grading based on the weighted one or more first contextual weighted keywords. The database is a private database pertaining to one or more media specific to an entity, and/or a public database pertaining to publicly available one or more media. Upon analysing the one or more stored media, the search module fetches the one or more stored media based on the results of the analysis.

In some embodiment, the contextual learning module further determines one or more second contextual weighted keywords for each of the one or more media stored in the database. Then, the keyword weighing module weighs each of the determined one or more second contextual weighted keywords for each of the one or more media stored in the database. Further, the one or more stored media in the database are represented by the corresponding weighted one or more second contextual weighted keywords. Accordingly, the search module compares the weighted one or more first contextual weighted keywords corresponding to the received search input with the weighted one or more second contextual weighted keywords corresponding to each of the one or more stored media to fetch the one or more stored media.

In some embodiment, the system includes a ranking module to rank the fetched one or more stored media based on both a number of times the one or more contextual weighted keywords were used in the one or more stored media and the weight of the one or more first contextual weighted keywords. In some embodiments, the system includes a rendering module to render the ranked one or more stored media to the user. In some embodiments, the user is facilitated to provide inputs over the rendered one or more stored media for refining of the contextual learning module, the keyword weighing module, the search module, the database, and the ranking module.

In some embodiments, the method for searching media based on contextual weighted keywords is disclosed. The method includes the steps of receiving search inputs for searching the media, may be received from a user. Further, the method includes the steps of determining one or more first contextual weighted keywords from the received searched inputs by employing one or more cognitive Artificial Intelligence (AI) models. Each of the determined one or more first contextual weighted keywords is weighted based on one or more pre-defined criteria. Further, the one or more pre-defined criteria include relevancy of the contextual weighted keywords with respect to context, facial expressions corresponding to the contextual keyword, acoustic characteristics corresponding to the contextual keyword, user inputs, or a combination thereof.

Further, the method includes the steps of weighing each of the determined one or more first contextual weighted keywords in terms of high, low, positive, negative, factor less than a pre-defined value, factor more than the pre-defined value or a combination thereof. Upon weighing, the method includes the steps of analysing one or more stored media in a database by performing searching, mapping, scoring, matching, aligning, and/or grading based on the weighted one or more first contextual weighted keywords. Then, the method includes the steps of fetching the one or more stored media based on the results of the analysis. Next, the method includes the steps of ranking the fetched one or more stored media based on both a number of times the one or more contextual weighted keywords were used in the one or more stored media and the weight of the one or more first contextual weighted keywords. Thereafter, the method includes the steps of rendering the ranked one or more stored media to the user.

In some embodiment of the present disclosure, the method includes the steps of determining one or more second contextual weighted keywords for each of the one or more media stored in the database. Further, the method includes the steps of weighing each of the determined one or more second contextual weighted keywords for each of the one or more media stored in the database. The method includes the steps of the one or more stored media in the database is represented by the corresponding weighted one or more second contextual weighted keywords. Furthermore, the method includes the steps of comparing the weighted one or more first contextual weighted keywords corresponding to the received search input with the weighted one or more second contextual weighted keywords corresponding to each of the one or more stored media to fetch the one or more stored media.

In some embodiments, the method includes the steps of facilitating the user to provide inputs over the rendered one or more stored media for refining the determination of the one or more first and second contextual weighted keywords, the weighing of each of the determined one or more first and second contextual weighted keywords, the analysing and fetching of the one or more stored media in the database, the database, and the ranking of the fetched one or more stored media.

The features and advantages of the subject matter hereof will become more apparent in light of the following detailed description of selected embodiments, as illustrated in the accompanying FIGUREs. As one of ordinary skill in the art will realize, the subject matter disclosed herein is capable of modifications in various respects, all without departing from the scope of the subject matter. Accordingly, the drawings and the description are to be regarded as illustrative.

### BRIEF DESCRIPTION OF THE DRAWINGS

The present subject matter will now be described in detail with reference to the drawings, which are provided as illustrative examples of the subject matter to enable those skilled in the art to practice the subject matter. It will be noted that throughout the appended drawings, features are identified by like reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 illustrates an exemplary environment of a system for searching media or data based on contextual weighted keywords, in accordance with an embodiment of the present disclosure;

FIG. 2 illustrates a block diagram for the system for searching media or data based on contextual weighted keywords, in accordance with an embodiment of the present disclosure;

FIG. 3 illustrates a ternary diagram of a triangular search by the system, in accordance with an embodiment of the present disclosure;

FIG. 4 illustrates various tables having exemplary data sets for an exemplary set of keywords, in accordance with an embodiment of the present disclosure;

FIG. 5 illustrates an exemplary operation of the system, in accordance with an embodiment of the present disclosure;

FIG. 6 illustrates a flowchart illustrating a method for searching media or data based on contextual weighted keywords, in accordance with an embodiment of the present disclosure; and

FIGS. 7 and 8 illustrate an exemplary computer unit in which or with which embodiments of the present disclosure may be utilized.

### DETAILED DESCRIPTION OF THE EMBODIMENTS

The detailed description set forth below in connection with the appended drawings is intended as a description of exemplary embodiments in which the presently disclosed disclosure can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed disclosure. However, it will be apparent to those skilled in the art that the presently disclosed disclosure may be practiced without these specific details. In some instances, well-known structures and devices are shown in block diagram form in order to avoid obscuring the concepts of the presently disclosed disclosure.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and/or firmware.

Embodiments of the present disclosure may be provided as a computer program product, which may include a non-transitory, machine-readable storage medium tangibly embodying thereon instructions, which may be used to program the computer (or other electronic devices) to perform a process. The machine-readable medium may include, but is not limited to, fixed (hard) drives, semiconductor memories, such as Read Only Memories (ROMs), Programmable Read-Only Memories (PROMs), Random Access Memories (RAMs), Erasable PROMs (EPROMs), Electrically Erasable PROMs (EEPROMs), flash memory or other types of media/machine-readable medium suitable for storing electronic instructions (e.g., computer programming code, such as software or firmware).

Various methods described herein may be practiced by combining one or more non-transitory, machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection. Based on the disclosure provided herein, one of ordinary skill in the art will appreciate a variety of ways in which connection or coupling exists in accordance with the definition.

Further, the term “module” may be software or hardware particularly programmed to receive an input, perform one or more processes using the input, and provide an output. The input, output, and processes performed by various modules will be apparent to one skilled in the art based on the present disclosure.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular name.

In the present specification, an embodiment showing a singular component should not be considered limiting. Rather, the subject matter preferably encompasses other embodiments including a plurality of the same component, and vice-versa, unless explicitly stated otherwise herein.

Moreover, applicants do not intend for any term in the specification or claims to be ascribed an uncommon or special meaning unless explicitly set forth as such. Further, the present subject matter encompasses present and future known equivalents to the known components referred to herein by way of illustration.

It will be understood that in the event parts of different embodiments have similar functions or uses, they may have been given similar or identical reference numerals or descriptions. It will be understood that such duplication of reference numerals is intended solely for efficiency and ease of understanding the present disclosure and are not to be construed as limiting in any way, or as implying that the various embodiments themselves are identical.

Unless defined otherwise, all technical and scientific terms used herein have the same meaning as commonly understood by one of the ordinary skills in the art to which the present disclosure belongs. However, some specific definitions are presented below.

The term “user” refers to the individual who interacts with the system primarily via the mobile autonomous device running the client-side application. Users can also be defined as registered users, non-registered users, or persons. The term “users” or “registered users” refers collectively to those individuals who have access to the system of the present disclosure, including employees, administrators, information technology specialists, and end users generally. The term “non-user” refers to any individual who does not have access to either the server-side and/or client-side applications described herein yet may be a recipient of the content generated by the same.

The term “video display” refers to devices upon which information may be displayed in a manner perceptible to a user, such as a computer monitor, cathode ray tube, liquid crystal display, light emitting diode display, touchpad or touchscreen display, and/or other means known in the art for emitting a visually perceptible output. Video displays may be electronically connected to a client device according to hardware and software known in the art.

The term “device” refers to, but is not limited to, vehicles, drones, stand-alone web cameras, cameras on laptops, tablets, mobile devices, doorbells, dashboards, security cameras, robots, autonomous equipment, and virtual, augmented, and mixed reality glasses/headsets.

In an implementation of a preferred embodiment of the disclosure, a “display page” may include a computer file residing in memory which may be transmitted from a server over a network to a mobile device that can store it in memory. A mobile device may receive non-transitionary computer-readable media, which may contain instructions, logic, data, or code that may be stored in the persistent or temporary memory of the mobile device. Similarly, one or more servers may communicate with one or more client devices across a network and may transmit computer files residing in memory. The network, for example, can include the Internet, wireless communication network, or any other network for connecting one or more client devices to one or more servers.

Any discussion of “client-side application” may also apply to a mobile application that is downloaded to or stored on a client device and/or mobile device.

Any discussion of “client”, “client device” or “mobile device” may also apply to any type of networked device, including but not limited to phones such as cellular phones (e.g. An iPhone, Android, Windows Mobile, Blackberry, or 10 any “smart phone”) or location-aware portable phones (such as GPS); embedded or specialty device; or viewing device (such as apple tv, Google TV, Roku, Smart TV, Picture Frame or other viewing device); personal computer, server computer, or laptop computer; personal digital assistants pads) such as Palm-based devices or tablet devices (such as iPad, Kindle Fire, or any tablet device); a roaming device such as a network-connected roaming device or other device capable of communicating wirelessly with a computer network; or any other type of network device that may communicate over a network and handle electronic transactions. Any discussion of any device mentioned may also apply to other devices.

At a client device, the “display page” or “user interface” may be interpreted by software residing on a memory of the client device, causing the computer file to be displayed on a video display in a manner perceivable by a user. The display pages (i.e., Screens) described herein may be created using a software language known in the art such as, for example, the hypertext mark-up language (“HTML”), the dynamic hyper-text mark-up language (“DHTML”), HTMLS, the extensible hypertext mark-up language (“XHTML”), the extensible mark-up language (“XML”), or another software language that may be used to create a computer file displayable on a video display in a manner perceivable by a user. Any computer-readable media with logic, code, data, and instructions, may be used to implement any software or steps or meth-otology. Where a network comprises the Internet, a display page may comprise a webpage of a type known in the art. The terms “page” or “display page” may include embedded functions comprising software programs stored on a memory, such as, for example, Cocoa, VBScript routines, Jscript routines, JavaScript routines, Java applets, ActiveX components, ASP.NET, AJAX, Flash applets, Silverlight applets, Adobe AIR routines, or any other scripting language.

A display page may comprise well-known features of graphical user interface technology, such as, for example, frames, windows, tabs, scroll bars, buttons, icons, menus, fields, and hyperlinks, and well-known features such as a touchscreen interface. Pointing to and touching on a graphical interface button, icon, menu option, or hyperlink also is known as “selecting” the button, icon, option, or hyperlink. Additionally, a “point and gesture” interface may be utilized, such as a hand-gesture-driven interface. Any other interface for interacting with a graphical user interface may be utilized. A display page according to the disclosure also may incorporate multimedia features. For example, a user interface may be provided for a web page or an application. An application may be accessed remotely or locally. A user interface may be provided for a mobile application (e.g., iPhone application), gadget, widget, tool, plug-in, or any other type of object, application, or software

Any of the client or server devices described may have tangible computer-readable media with logic, code, or instructions for performing any actions described herein or running any algorithm. The devices with such computer-readable media may be specially programmed to perform the actions dictated by the computer-readable media. In some embodiments, the devices may be specially programmed to perform one or more tasks relating to blood glucose management. In some embodiments, the devices may communicate with or receive data collected from one or more measurement or sensing devices, which may collect physiological data from a subject or a sample collected from a subject. The term “time” refers to a chronological time or time-frame, including but not limited to morning, afternoon, evening, breakfast, lunch, dinner, nighttime, beginning, end, etc.

Other examples of protocols or standard communications mean between the server and the client included within the scope of this disclosure include, but are not limited to, standard telephone lines, LAN or WAN links (e.g., T1, T3, 56 kb, X.25), broadband connections (ISDN, Frame Relay, ATM), and wireless connections using a variety of communication protocols (e.g. HTTP, HTTPS, XML, JSON, TCP/IP, IPX, SPX, NetBIOS, Ethernet, RS232, messaging application programming interface (MAPI) protocol, real-time streaming protocol (RTSP), a real-time streaming protocol used for user datagram protocol scheme (RTSPU), the Progressive Networks Multimedia (PDN) protocol, manufacturing message specification (MMS) protocol, the wireless application protocol (WAP) and direct asynchronous connections

A system for searching media based on contextual weighted keywords is disclosed. The system may include the steps of receiving search inputs for searching the media from a user. Further, the system may include the steps of determining one or more first contextual weighted keywords from the received searched inputs by employing one or more cognitive Artificial Intelligence (AI) models. The system may further include the steps of weighing each of the determined one or more first contextual weighted keywords in terms of high, low, positive, negative, factor less than a pre-defined value, and/or factor more than the pre-defined value. Also, the system may include the steps of analysing one or more stored media in a database by performing searching, mapping, scoring, matching, aligning, and/or grading based on the weighted one or more first contextual weighted keywords. Next, the system may include the steps of fetching the one or more stored media based on the results of the analysis and ranking the fetched one or more stored media based on both a number of times the one or more contextual weighted keywords were used in the one or more stored media and the weight of the one or more first contextual weighted keywords. Thereafter, the system may include the steps of rendering the ranked one or more stored media to the user.

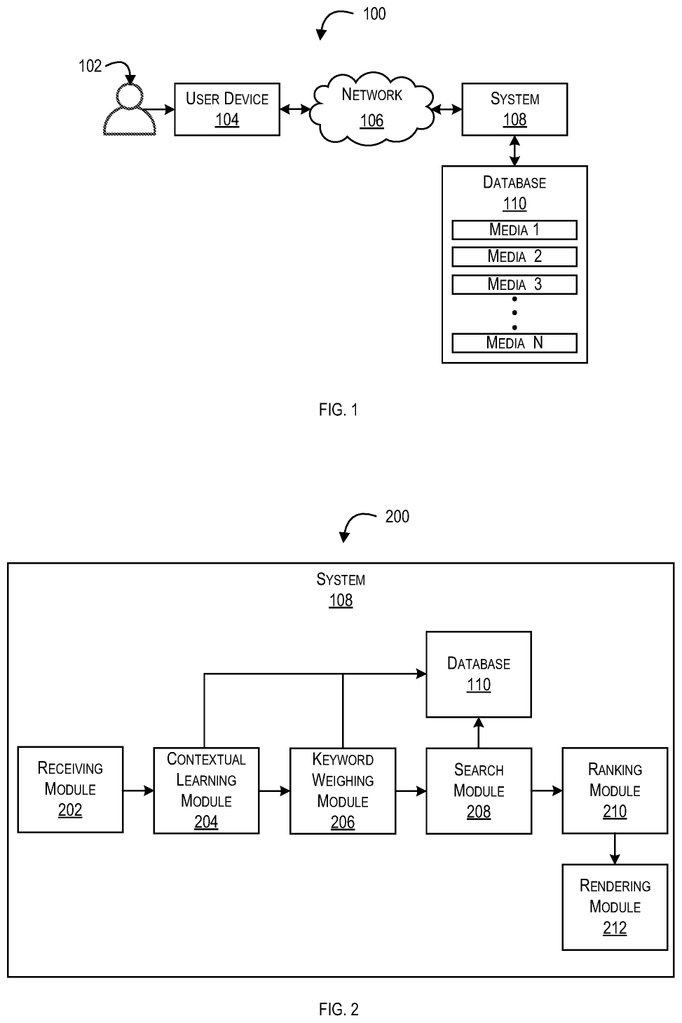

FIG. 1 illustrates an exemplary environment 100 of a system 108 for searching media or data based on contextual weighted keywords, in accordance with an embodiment of the present disclosure. In an embodiment, the exemplary environment 100 may include a user device 104 associated with the user 102, a network 106, the system 108, and a database 110. For the purpose of the disclosure, the media or data may, without any limitation, include textual content, data sets, unstructured data, structured data, a document, an image, an audio, and/or a video. For the sake of brevity, the term ‘media’ has been used, however, it may be apparent to a person skilled in the art that the media (wherever used) may also include data, without departing from the scope of the disclosure. In an embodiment, the system 108 may be implemented on an electronic device such as a computer or an electronic chip that may be installed in the electronic device. Such electronic chip may be utilized for storing, learning, searching, and/or mapping, as would be explained in detailed in the following paragraphs. In another embodiment, the system 108 may be implemented on a searching device exclusively designed for searching media files of the database 110. In yet another embodiment, the system 108 may be implemented on a server that may, without any limitation, include a cloud server. The system 108 may include or may be communicatively coupled to the database 110 having one or more media including corresponding a textual content, a document, an image, an audio, a video, a transcript, and/or other electronic files. In an embodiment, the database 110 is a private database pertaining to one or more media specific to an entity such as an individual and an organization. In other embodiment, the database 110 may be a public database pertaining to publicly available one or more media such as patents on Google patents.

In an embodiment, the user device 104 may correspond to an electronic device having a user interface and network connectivity to connect to the network 106. Thus, for example, the user device 104 may, without any limitation, include a mobile phone, a laptop, a tablet, and a Personal Digital Assistant (PDA) device. The network 106 may, without limitation, include a Local Area Network (LAN), a Wide Area Network (WAN), a wireless network, the Internet, and the like. In an embodiment, to perform searching of the one or more media files In the database 110, the user 102 may give search input, such as in the form of a sentence, one or more keywords, a search string, an image, a document, an audio file, and a video file. Further, if the search inputs are not in textual forms (such as an image, a document, an audio file, and/or video file), then the system 108 may first convert the provided search inputs into the textual form, such as by Optical Character Recognition (OCR), transcribing, Natural Language Processing (NLP), or the like.

Once the search inputs are converted into the textual form, the system 108 may determine one or more contextual weighted keywords from the received search inputs. Unlike conventional keywords which correspond to an identified word in a content, the contextual weighted keywords may be understood as one or more words having similar contextual meaning to the identified word. For example, considering a job vacancy description “need a programmer for an IT company”, the keywords may be “programmer” and “IT company”, however, the contextual weighted keywords may be “programmer”, “coder”, “developer”, “software engineer”, “Java Coding”, “C++ coding”, “IT company”, “software company”, “IT service enterprise”, or the like. Further, the system 108 may weigh the determine one or more contextual weighted keywords to identify which contextual weighted keywords are more relevant. For example, the contextual weighted keywords pertaining to the “programmer” may be weighed higher than the contextual weighted keywords pertaining to the “IT company” since the skill of the person would be more important than the company the person is working on, however, the contextual keyword pertaining to the “IT company” may just be weighted lower and not removed since a person working in a Multi-National Company (MNC) may be assumed to be more skilled than a person working in a small company.

In some embodiment, the system 108 may analyze the each of the media file in the database 110 based on the contextual weighted keywords to identify relevant media files for the search. Upon identification, the system 108 may rank the relevant media files based on the number of times such contextual weighted keywords appear in the relevant media files while considering the weights assigned to the contextual weighted keywords. The system may then render the ranked relevant media files to the user. For example, consider a recruitment post “Need Java developer with preferable, but not necessary, C++ experience”. In such a scenario, the system 108 may identify contextual weighted keywords pertaining to Java developer and C++ developer such as “Java developer”, “Java Programmer”, “Java Coder”, “Java Language”, “C++ developer”, “C++ Programmer”, “C++ Coder”, and “C++ Language”. Further, based on the recruitment post, the system 108 may assign higher weight to contextual weighted keywords pertaining to “Java developer” than “C++ developer” and thus may fetch resumes of both the java developers and C++ developers while ranking Java developers higher than the C++ developers to render to the user 102.

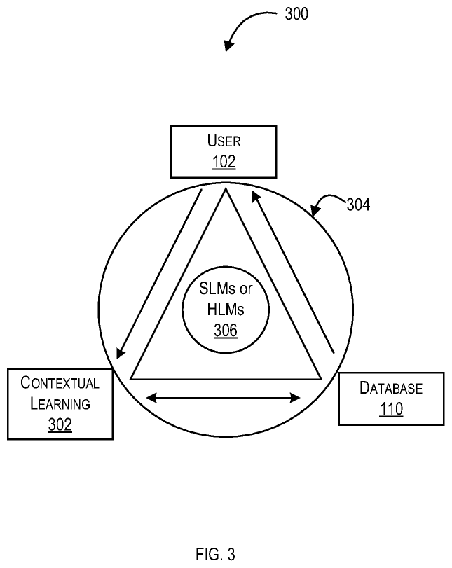

FIG. 2 illustrates a block diagram 200 for the system 108 for searching media based on contextual weighted keywords, in accordance with an embodiment of the present disclosure. In an embodiment of the present disclosure, the system 108 may include a receiver module 202, a contextual learning module 204, a keyword weighing module 206, a search module 208, a ranking module 210, a rendering module 212, and the database 110. The receiver module 202, the contextual learning module 204, the keyword weighing module 206, the search module 208, the ranking module 210, the rendering module 212, and the database 110 may be communicatively coupled to a memory and a processor of the system 108.

The processor may control the operations of the receiver module 202, the contextual learning module 204, the keyword weighing module 206, the search module 208, the ranking module 210, the rendering module 212, and the database 110. In an embodiment of the present disclosure, the processor and the database 110 may form a part of a chipset installed in the system 108. In another embodiment of the present disclosure, the database 110 may be implemented as a static memory or a dynamic memory. In an example, the database 110 may be internal to the system 108, such as an onside-based storage. In another example, the database 110 may be external to the system 108, such as cloud-based storage. Further, the processor may be implemented as one or more microprocessors, microcomputers, digital signal processors, central processing units, state machines, logic circuitries, and/or any devices that manipulate signals based on operational instructions.

In some embodiment, the receiving module 202 may receive the search inputs for searching the media from the user device 104 of the user 102. The search inputs may be in the form of a sentence, one or more keywords, a search string, an image, a document, an audio file, and a video file. In an embodiment, if the search inputs are in textual form, such as a sentence, keywords, or search string, then it may be utilized directly. In another embodiment, if the search inputs are not in textual form, such as an image, a document, an audio file, and/or video file, then the system 108 may first pre-process the search inputs to convert the provided search inputs into the textual form. For example, the image data may be pre-processed via Optical Character Recognition (OCR), and audio/video data may be pre-processed via transcribing or tone analyzer in conjunction with Natural Language Processing (NLP) to convert them in textual form, respectively.

In some embodiment, the contextual learning module 204 may determine one or more first contextual weighted keywords from the received searched inputs by employing one or more cognitive Artificial Intelligence (AI) models. For example, the one or more cognitive AI models may, without any limitation, include Large Language Models (LLMs), hybrid language models (HLMs) from cognitive services, OpenAI GPT-3 or 4, Google BERT, Google BARD, RoBERTa, LaMDA, PaLM, Flamingo, ILaMA, Claude, Cohere, Falcon, Guanaco-65B, or the like. Further, output of such cognitive AI models may be fine tuned to further analyze them using Machine Learning (ML), deep learning, or hybrid models to specific areas, data, or content to improve search or mapping results. In an embodiment, the contextual learning module 204 may analyze the received search inputs to create a detailed understanding of the topic, document, content, or media files. Such detailed understanding is utilized to determine the one or more contextual weighted keywords. It may be understood that the one or more contextual weighted keywords may also include key phrases, key sentences, any form of output with key statements, and/or combination of keywords.

In some embodiment, the keyword weighing module 206 may weigh each of the determined one or more first contextual weighted keywords in terms of high, low, positive, negative, factor less than a pre-defined value, and/or factor more than the pre-defined value. In an embodiment, the keyword weighing module 206 may weigh each of the determined one or more first contextual weighted keywords based on one or more pre-defined criteria. The one or more pre-defined criteria may include relevancy of contextual keyword with respect to context, facial expressions corresponding to the contextual keyword, acoustic characteristics corresponding to the contextual keyword, and/or user inputs. It may be understood that one or more techniques known in the art may be utilized to identify the contextual importance of one word against another word through facial expressions and/or acoustic characteristics, such as by identifying emphasis on each word through lip movement, eye movement, and high/low pitch/frequency of the voice. Such techniques may be especially important when the inputs are in the form of audio and/or video.

In some embodiment, the search module 208 may analyze the one or more stored media in the database 110 by performing searching, mapping, scoring, matching, aligning, and/or grading based on the weighted one or more first contextual weighted keywords. Further, the search module 208 may fetch the one or more stored media based on the results of the analysis.

Exploring briefly, the maintenance of the one or more media in the database 110 by the system 108. The contextual learning module 204 may determine one or more second contextual weighted keywords for each of the one or more media stored in the database 110. Further, the keyword weighing module 206 may weigh each of the determined one or more second contextual weighted keywords for each of the one or more media stored in the database 110. Such contextual weighted keywords may be utilized to represent the one or more stored media in the database 110. For example, consider a media file associated with a resume having a description: “a Java programmer working in XYZ company”. In this exemplary scenario, the system 108 may determine the contextual weighted keywords “Java programmer”, “programmer”, “coder”, “developer”, “software engineer”, “Java Coding”, “XYZ company”, “IT company”, “software company”, “IT service enterprise”, or the like. Then, the system 108 may weigh the determine one or more contextual weighted keywords to represent the corresponding media file in the database 110. For example, the contextual weighted keywords pertaining to the “Java programmer” may be weighed higher than the contextual weighted keywords pertaining to the “XYZ company” since an organization would be more interested in the skills rather than the organization a person is working in. However, it may be noted that, the one or more contextual weighted keywords may also be utilized and may not be deleted since they are also important in some scenarios. For example, however, the contextual weighted keywords pertaining to the “XYZ company” may be less useful than the contextual weighted keywords pertaining to the “Java programmer”, they may not be deleted but only weighted lower since in some scenarios, such as where a recruiter wants to check only the employees from a particular company, these contextual weighted keywords may also play an important part. Accordingly, the system 108 may represent each of the media files (for example, the resumes) in the database 110 by the corresponding contextual weighted keywords sorted by the assigned weights.

Explaining back the operation of the search module 208, the search module 208 may compare the weighted one or more first contextual weighted keywords corresponding to the received search input with the weighted one or more second contextual weighted keywords corresponding to each of the one or more stored media to fetch the one or more stored media. Based on the results of the comparison, the search module 208 may fetch the one or more stored media.

In some embodiment, the ranking module 210 may rank the fetched one or more stored media. The fetched one or more stored media may be ranked based on both a number of times the one or more contextual weighted keywords were used in the one or more stored media and the weight of the one or more first contextual weighted keywords. Thus, in the example of the recruitment post “Need Java developer with preferable, but not necessary, C++ experience”, the system 108 may assign higher weight to contextual weighted keywords pertaining to “Java developer” (for example, a multiplier of 1.5) than “C++ developer” (for example, a multiplier of 0.5). Thus, considering two resumes having contextual weighted keywords pertaining to both Java and C++ i.e., resume 1 with 100 words related to Java and 50 words related to C++ (i.e. total 150 relevant words), and resume 2 with 50 words related to Java and 150 words related to C++ (i.e., total 200 relevant words). The ranking module 210 may compare the resume 1 and resume 2 in terms of both the number of times the one or more contextual weighted keywords were used in the two resumes and the weight of the one or more first contextual weighted keywords. For example, resume 1: Ranking score=(100×1.5)+(50×0.5) i.e., 175, and resume 2: Ranking score=(50×1.5)+(150×0.5) i.e., 150. Thus, the ranking module 210 may rank resume 1 higher than resume 2. It may be noted that the conventional systems that work on word-to-word matching may rank resume 2 higher than resume 1 based on the mere fact that it has more number of relevant words i.e., 200 in comparison to 150. Accordingly, the system 108 provides highly accurate search results based on the contextual weighted keywords associated with the search input and the one or more media stored in the database 110.

In some embodiments, the rendering module 212 may render the ranked one or more stored media to the user 102. For the purpose of the disclosure, the rendering may, without any limitation, include displaying a list of media, displaying the top-ranked media, opening the top-ranked media (such as playing the audio or video), displaying the list of media along with associated shortcuts or references to access them, or the like. In some embodiment, the system 108 may also facilitate the user 102 to provide inputs/comments/feedbacks over the rendered one or more stored media. Such inputs/comments/feedbacks may be utilized for refining of the contextual learning module 204, the keyword weighing module 206, the search module 208, the database 110, and/or the ranking module 210.

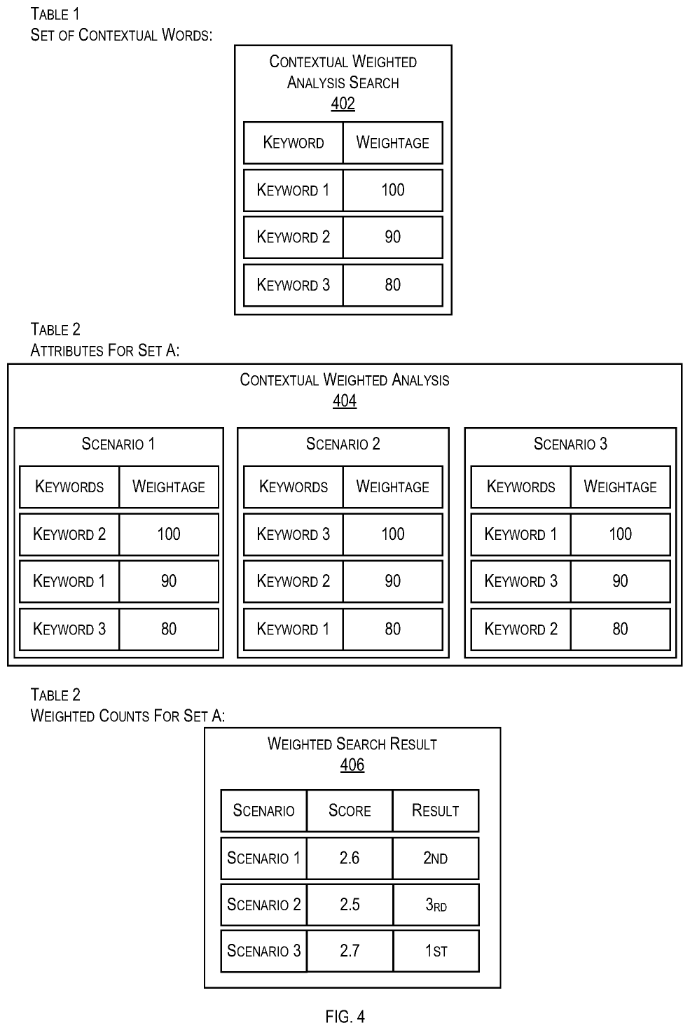

FIG. 3 illustrates a ternary diagram 300 of a triangular search by the system 108, in accordance with an embodiment of the present disclosure. In some embodiments, the ternary diagram 300 illustrates the user 102 performing the triangular search by utilizing a Large Language Model (LLM) 304, and a Small Language Model (SLM) or a Hybrid Language Model (HLM) 306 to develop contextual learning 302 searching and mapping media stored in the database 110. In some embodiment, the LLM may, without any limitation, include Azure Cognitive AI, OpenAI or the like, and the SLM or HLM may, without any limitation, include a Machine Learning (ML) Models or Deep Learning (DL) Models developed on a private customer data of an entity. The triangular search approach may enhance the accuracy of searching due to contextual weighted search capabilities. For example, in hiring and recruiting streamlines, the triangular search may enhance the recruitment process by utilizing ML-based algorithms to decipher the context and relevance of each keyword within a candidat“s resume, effectively matching the right person for the right job. Further, the triangular search may ensure a more accurate and efficient search while reducing the time spent, such as by recruiters manually sifting through resumes. This in turn leads to quicker outputs, increased productivity for the businesses, and substantial cost savings. Additionally, the triangular search improves the quality of the search by identifying critical contextual information through weighted search results, for example, it is able to pinpoint the most suitable candidates who not only possess the relevant skills and experience but also have the desired cultural fit for a specific organization.

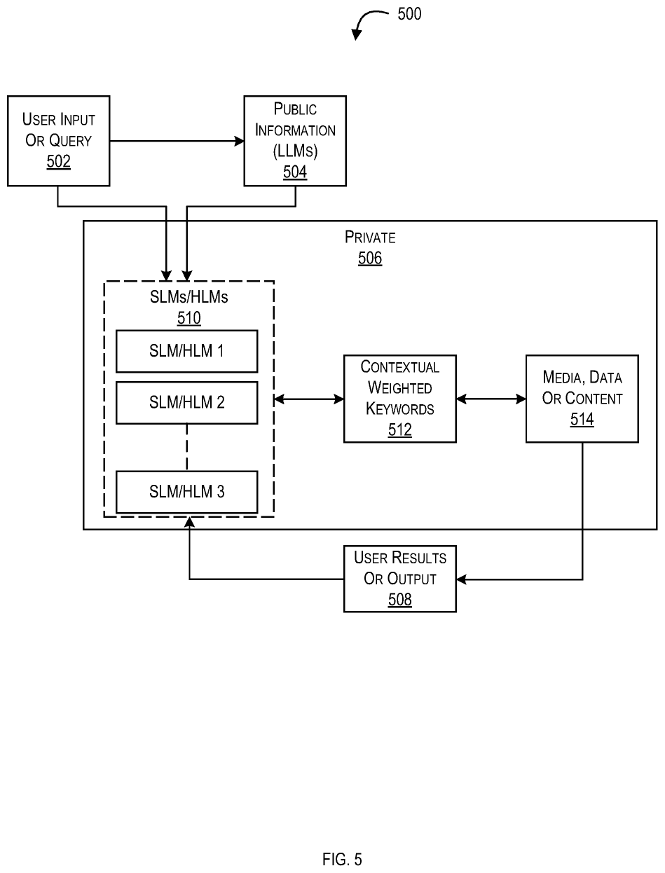

FIG. 4 illustrates various tables having exemplary data sets for an exemplary set of keywords, in accordance with an embodiment of the present disclosure.

Table 1, a table for contextual weighted analysis search 402 is illustrated that specifies the exemplary set of keywords i.e., keyword 1, keyword 2, and keyword 3 along with the weightage provided to the keywords for the searching i.e., 100 for keyword 1, 90 for keyword 2, and 80 for keyword 3.

Table 2, a table for contextual weighted analysis 404 is illustrated that specifies statistics for keywords in three scenarios (i.e., three media). The first column, in the illustrated embodiment, indicates the weightage assignment of the three keywords in first scenario i.e., 100 to keyword 2, 90 to keyword 1, and 80 to keyword 3. The second column, in the illustrated embodiment, indicates the weightage assignment of the three keywords in second scenario i.e., 100 to keyword 3, 90 to keyword 2, and 80 to keyword 1. The third column, in the illustrated embodiment, indicates the weightage assignment of the three keywords in third scenario i.e., 100 to keyword 1, 90 to keyword 3, and 80 to keyword 2.

Table 3, a table for weighted search result 406 is illustrated that specifies weighted counts for a set of keywords i.e., the keyword 1, keyword 2, and keyword 3. Such weights may be statically defined for each attribute or may be variable. In variable embodiments, the weights may be dynamically updated in real time, e.g., based on user feedback. In some embodiments, similar weights for multiple keywords may be applied to one or more counts. In some embodiments, one or more weights may be applied directly to each count of a word, e.g., before it is added to a running count for a set of words for a recording. As another example, if keyword 1 is more desirable than the keyword 2 that is more desirable than the keyword 3, then the weight for the keyword 1 may be 1, the weight for the keyword 2 may be 0.5, and the weight for the keyword 3 may be 0.25 during the searching. Accordingly, the average scores may be assigned to each scenario based on the importance of each keyword in the search input and the importance of each keyword in each scenario. As illustrated, scenario 1 may be assigned a score of 2.6, scenario 2 may be assigned a score of 2.5, and scenario 3 may be assigned a score of 2.7, thus, ranking the scenario 1, scenario 2, and scenario 3 as 2^{nd}, 3^{rd} and 1^{st}.

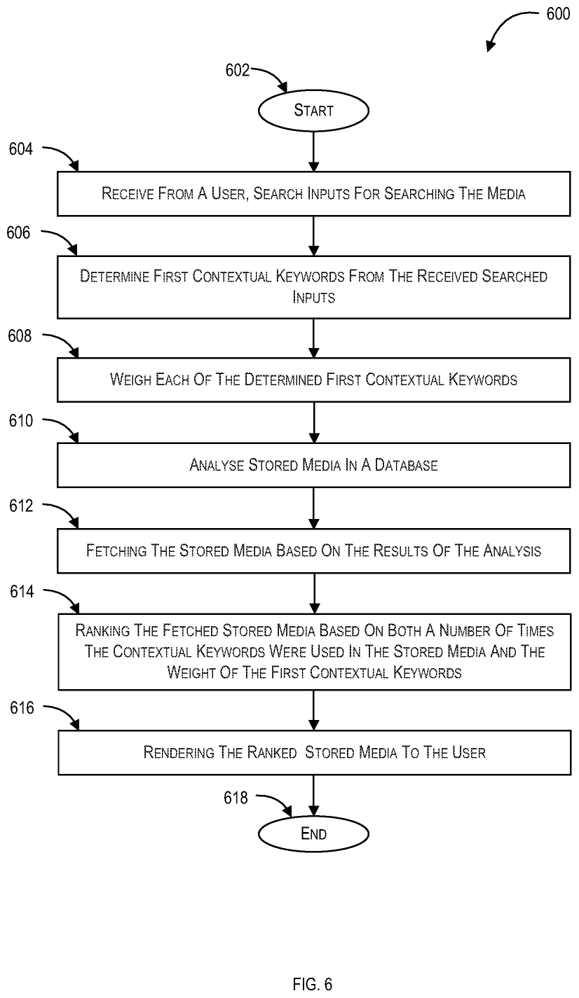

FIG. 5 illustrates an exemplary operation 500 of the system 108, in accordance with an embodiment of the present disclosure. Such exemplary operation 500 may be an implementation of the system 108 by an entity that utilizes both the public information and private information. For the purpose of this implementation, the public information may correspond to publicly available information that is relevant to the entity, for example, any publicly available information related to the cars for a car manufacturing company. Further, the private information may correspond to personal information of the entity, for example, trade secret, business process, or internal confidential information. In such systems 108, when the user 102 provides search inputs or queries, as shown by the box 502, then those inputs may first be provided to the LLM based on the public information, as shown by the box 504 to determine contextual weighted keywords for the search inputs. Then, the determined contextual weighted keywords and the received search inputs may be processed privately, as shown by 506 for personalized and accurate searching. For private processing, the determined contextual weighted keywords and the received search inputs may be provided to the SLM or HLM 510 having one or more small sub SLMs or HLMs to determine one or more contextual weighted keywords relevant to the entity. Then, the system 108 may perform weighing of the determined one or more relevant contextual weighted keywords to obtain contextual weighted keyword 512. The searching may be further performed by analyzing the obtained contextual weighted keywords 512 against the one or more media stored in the database 110 to obtain relevant media, data, or content, as shown by the box 514. Such obtained relevant data may then be presented to the user 102 as search results or output 508. Additionally, the such search results or output 508 may also be provided to the SLMs or HLMs 510 as feedbacks for training and refining of the SLMs or HLMs 510 for improving results in the future.

In some embodiment, the system 108 may improve reliability of information by implementing additional data discovery processes and quality checks. Further, the system 108 may overcome issues related to usability through regular feedback from the user 102 to improve the data discovery, design, and user interface dynamically. Additionally, the system 108 may overcome the security and privacy issues by robust data security protocols, privacy policy and terms of service, complying with General Data Protection Regulation (GDPR), two-factor authentication, regular monitoring/updating, and/or providing user control over data. Thus, the system 108 provides a cost-effective, easy-to-use, and customizable solution to facilitate efficient triangle search that offers advanced search capabilities and maintains the privacy and security of user information.

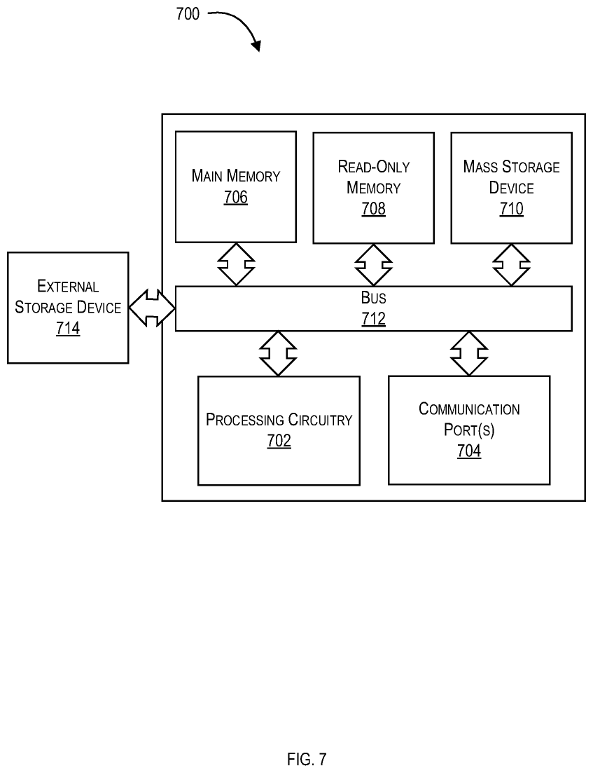

FIG. 6 illustrates a flowchart 600 illustrating a method for searching media based on contextual weighted keywords, in accordance with an embodiment of the present disclosure. The method starts at step 602.

At first, search inputs for searching the media may be received from a user, at step 604. The media may correspond to textual content, a document, an image, an audio, and/or a video. Further, the search inputs may include textual inputs, documents, audio, videos, and/or images. At step 606, one or more first contextual weighted keywords may be determined from the received searched inputs by employing one or more cognitive Artificial Intelligence (AI) models. Each of the determined one or more first contextual weighted keywords may be weighted based on one or more pre-defined criteria. Further, the one or more pre-defined criteria may include the relevancy of contextual keyword with respect to context, facial expressions corresponding to the contextual keyword, acoustic characteristics corresponding to the contextual keyword, user inputs, or a combination thereof.

Then, each of the determined one or more first contextual weighted keywords may be weighted, at step 608, in terms of high, low, positive, negative, factor less than a pre-defined value, factor more than the pre-defined value, or a combination thereof. Upon weighing, one or more stored media in a database may be analysed, at step 610, by performing searching, mapping, scoring, matching, aligning, and/or grading based on the weighted one or more first contextual weighted keywords. The database may be a private database pertaining to one or more media specific to an entity and/or a public database pertaining to publicly available one or more media. Upon analyzing the one or more stored media, the one or more stored media may be fetched, at step 612, based on the results of the analysis.

After fetching the one or more stored media, the fetched one or more stored media may be ranked, at step 614, based on both a number of times the one or more contextual weighted keywords were used in the one or more stored media and the weight of the one or more first contextual weighted keywords. Thereafter, at step 616, the ranked one or more stored media may be rendered to the user.

In some embodiment of the present disclosure, the method may include determining one or more second contextual weighted keywords for each of the one or more media stored in the database. Further, the method may include weighing each of the determined one or more second contextual weighted keywords for each of the one or more media stored in the database. The method may also include the one or more stored media in the database is represented by the corresponding weighted one or more second contextual weighted keywords. Furthermore, the method may also include the steps of comparing the weighted one or more first contextual weighted keywords corresponding to the received search input with the weighted one or more second contextual weighted keywords corresponding to each of the one or more stored media to fetch the one or more stored media.

In some embodiments, the user is facilitated to provide inputs over the rendered one or more stored media for refining of at least one of: the determination of the one or more first and second contextual weighted keywords, the weighing of the each of the determined one or more first and second contextual weighted keywords, the analysing and fetching of the one or more stored media in the database, the database, and the ranking of the fetched one or more stored media. The method ends at step 618.

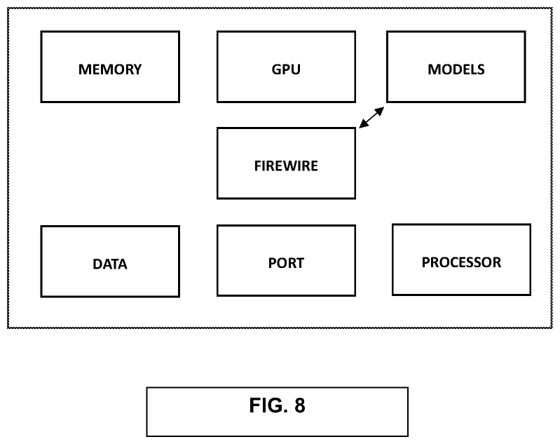

FIG. 7 illustrates an exemplary computer system in which or with which embodiments of the present disclosure may be utilized. Depending upon the implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software and/or firmware. As shown in FIG. 7, the computer system 700 includes an external storage device 714, a bus 712, a main memory 706, a read-only memory 708, a mass storage device 710, a communication port(s) 704, and a processing circuitry 702.

Those skilled in the art will appreciate that the computer system 700 may include more than one processing circuitry 702 and one or more communication ports 704. The processing circuitry 702 should be understood to mean circuitry based on one or more microprocessors, microcontrollers, digital signal processors, programmable logic devices, Field-Programmable Gate Arrays (FPGAs), Application-Specific Integrated Circuits (ASICs), and Graphic Processing Unit (GPU) etc., and may include a multi-core processor (e.g., dual-core, quad-core, Hexa-core, or any suitable number of cores) or supercomputer. In some embodiments, the processing circuitry 702 is distributed across multiple separate processors or processing units, for example, multiple of the same type of processing units (e.g., two Intel Core i7 processors) or multiple different processors (e.g., an Intel Core i5 processor and an Intel Core i7 processor). Examples of the processing circuitry 702 include, but are not limited to, an Intel® Itanium® or Itanium 2 processor(s), AMD® Opteron® or Athlon MPO processor(s), Motorola® lines of processors, System on Chip (SoC) processors, or other future processors. The processing circuitry 702 may include various modules associated with embodiments of the present disclosure.

The communication port 704 may include a cable modem, Integrated Services Digital Network (ISDN) modem, a Digital Subscriber Line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. The communication port 704 may be any RS-232 port for use with a modem-based dialup connection, a 10/100 Ethernet port, a Gigabit, or a 10 Gigabit port using copper or fiber, a serial port, a parallel port, or other existing or future ports. The communication port 704 may be chosen depending on a network, such as a Local Area Network (LAN), Wide Area Network (WAN), or any network to which the computer system 700 may be connected.

The main memory 706 may include Random Access Memory (RAM) or any other dynamic storage device commonly known in the art. Read-only memory (ROM) 708 may be any static storage device(s), e.g., but not limited to, a Programmable Read-Only Memory (PROM) chips for storing static information, e.g., start-up or BIOS instructions for the processing circuitry 702.

The mass storage device 710 may be an electronic storage device. As referred to herein, the phrase “electronic storage device” or “storage device” should be understood to mean any device for storing electronic data, computer software, or firmware, such as random-access memory, read-only memory, hard drives, optical drives, Digital Video Disc (DVD) recorders, Compact Disc (CD) recorders, BLU-RAY disc (BD) recorders, BLU-RAY 3D disc recorders, Digital Video Recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement the main memory 706. The mass storage device 710 may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

The bus 712 communicatively couples the processing circuitry 702 with the other memory, storage, and communication blocks. The bus 712 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processing circuitry 702 to the software system.

Optionally, operator and administrative interfaces, e.g., a display, keyboard, and a cursor control device, may also be coupled to the bus 712 to support direct operator interaction with the computer system 700. Other operator and administrative interfaces may be provided through network connections connected through the communication port(s) 704. The external storage device 714 may be any kind of external hard drives, floppy drives, IOMEGA® Zip Drive, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the exemplary computer system limit the scope of the present disclosure.

The computer system 700 may be accessed through a user interface. The user interface application may be implemented using any suitable architecture. For example, it may be a stand-alone application wholly implemented on the computer system 700. The user interfaces application and/or any instructions for performing any of the embodiments discussed herein may be encoded on computer-readable media. Computer-readable media includes any media capable of storing data. In some embodiments, the user interface application is client-server-based. Data for use by a thick or thin client implemented on an electronic device computer system 700 is retrieved on-demand by issuing requests to a server remote to the computer system 700. For example, computer system 700 may receive inputs from the user via an input interface and transmit those inputs to the remote server for processing and generating the corresponding outputs. The generated output is then transmitted to the computer system 700 for presentation to the user.

As illustrated in FIG. 8, the system 700 may be utilized to have a chip to host hybrid language models build in. The chip may be implemented with integrated circuit using any suitable architecture. For example, it may be a stand-alone application model wholly used for system 700. The chip contains memory, data, GPU, ports, processes, models like small, hybrid, or hyper language models. The chip models can be maintained with firewire updates.

While embodiments of the present disclosure have been illustrated and described, it will be clear that the disclosure is not limited to these embodiments only. Numerous modifications, changes, variations, substitutions, and equivalents will be apparent to those skilled in the art without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, the terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced. Where the specification claims refer to at least one of something selected from the group consisting of A, B, C . . . . And N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded to the widest scope consistent with the principles and novel features disclosed herein. It is contemplated that additional embodiments are within the spirit and true scope of the disclosed subject matter.

What is claimed is:

1. A system for searching media or data based on contextual weighted keywords, the system comprises:
a receiving module to receive, from a user, search inputs for searching the media or data;
a contextual learning module to determine one or more first contextual weighted keywords from the received searched inputs by employing one or more cognitive Artificial Intelligence (AI) models;
a keyword weighing module to weigh each of the determined one or more first contextual weighted keywords in terms of at least one of: high, low, positive, negative, factor less than a pre-defined value, and factor more than the pre-defined value;
a search module to:
analyse one or more stored media or data in a database by performing at least one of: searching, mapping, scoring, matching, aligning, and grading based on the weighted one or more first contextual weighted keywords; and
fetch the one or more stored media or data based on the results of the analysis;
a ranking module to rank the fetched one or more stored media or data based on both a number of times the one or more contextual weighted keywords were used in the one or more stored media or data and the weight of the one or more first contextual weighted keywords; rank is also determined based one or more locations or time in a one or more stored media or data; and
a rendering module to render the ranked one or more stored media or data to the user.

2. The system of claim 1, wherein the media or data correspond to at least one of: a textual content, datasets, unstructured data, structured data, a document, an image, an audio, and a video.

3. The system of claim 1, wherein the search inputs include at least one of: textual inputs, documents, audio, videos, and images.

4. The system of claim 1, wherein the keyword weighing module weighs each of the determined one or more first contextual weighted keywords based on one or more pre-defined criteria including at least one of: relevancy of contextual keyword with respect to context, facial expressions corresponding to the contextual keyword, acoustic characteristics corresponding to the contextual keyword, and user inputs.

5. The system of claim 1, wherein the contextual learning module further determines one or more second contextual weighted keywords for each of the one or more media or data stored in the database.

6. The system of claim 5, wherein the keyword weighing module further weighs each of the determined one or more second contextual weighted keywords for each of the one or more media or data stored in the database.

7. The system of claim 6, wherein the one or more stored media or data in the database is represented by the corresponding weighted one or more second contextual weighted keywords.

8. The system of claim 7, wherein the search module compares the weighted one or more first contextual weighted keywords corresponding to the received search input with the weighted one or more second contextual weighted keywords corresponding to each of the one or more stored media or data to fetch the one or more stored media or data.

9. The system of claim 1, wherein the database is at least one of: a private database pertaining to one or more media or data specific to an entity, and a public database pertaining to publicly available one or more media or data.

10. The system of claim 1, wherein the user is facilitated to provide inputs over the rendered one or more stored media or data for refining of at least one of: the contextual learning module, the keyword weighing module, the search module, the database, and the ranking module.

11. A method for searching media or data based on contextual weighted keywords, the method comprises:
receiving, from a user, search inputs for searching the media or data;
determining one or more first contextual weighted keywords from the received searched inputs by employing one or more cognitive Artificial Intelligence (AI) models;
weighing each of the determined one or more first contextual weighted keywords in terms of at least one of: high, low, positive, negative, factor less than a pre-defined value, and factor more than the pre-defined value;
analysing one or more stored media or data in a database by performing at least one of: searching, mapping, scoring, matching, aligning, and grading based on the weighted one or more first contextual weighted keywords;
fetching the one or more stored media or data based on the results of the analysis;
ranking the fetched one or more stored media based on both a number of times the one or more contextual weighted keywords were used in the one or more stored media or data and the weight of the one or more first contextual weighted keywords; rank is also determined based one or more locations or time in a one or more stored media or data; and
rendering the ranked one or more stored media or data to the user.

12. The method of claim 11, wherein the media or data correspond to at least one of: a textual content, datasets, unstructured data, structured data, a document, an image, an audio, and a video.

13. The method of claim 11, wherein the search inputs include at least one of: textual inputs, documents, audio, videos, and images.

14. The method of claim 11, wherein each of the determined one or more first contextual weighted keywords are weighted based on one or more pre-defined criteria including at least one of: relevancy of contextual keyword with respect to context, facial expressions corresponding to the contextual keyword, acoustic characteristics corresponding to the contextual keyword, and user inputs.

15. The method of claim 11, further comprises determining one or more second contextual weighted keywords for each of the one or more media or data stored in the database.

16. The method of claim 15, further comprises weighing each of the determined one or more second contextual weighted keywords for each of the one or more media or data stored in the database.

17. The method of claim 16, wherein the one or more stored media or data in the database is represented by the corresponding weighted one or more second contextual weighted keywords.

18. The method of claim 17, further comprises comparing the weighted one or more first contextual weighted keywords corresponding to the received search input with the weighted one or more second contextual weighted keywords corresponding to each of the one or more stored media or data to fetch the one or more stored media or data.

19. The method of claim 11, wherein the database is at least one of: a private database pertaining to one or more media or data specific to an entity, and a public database pertaining to publicly available one or more media or data.

20. The method of claim 11, wherein the user is facilitated to provide inputs over the rendered one or more stored media or data for refining of at least one of: the determination of the one or more first and second contextual weighted keywords, the weighing of the each of the determined one or more first and second contextual weighted keywords, the analysing and fetching of the one or more stored media or data in the database, the database, and the ranking of the fetched one or more stored media or data.

21. An apparatus, comprising:
one or more processors; and
one or more memories having program instructions stored thereon that are executable by the one or more processors to:
store for each of a plurality of different entities, one or more recordings that include either in data (structured or unstructured), documents, audio, and video data or vice versa;
generate a transcript of audio data from each of the recordings;
receive multiple sets of information, each set specifying one or more words;
determine one or more locations in which words in ones of the sets were used in the one or more transcripts, data, or documents;
perform facial recognition using the video data to determine facial attributes of a speaker at different times in the video data corresponding to ones of the one or more locations in the one or more transcripts;
perform audio analysis using the audio data to determine vocal attributes of a speaker at different times in the audio data corresponding to ones of the one or more locations in the one or more transcripts;
determine and store weight information for occurrences of words in ones of the sets based on the determined facial attributes, vocal attributes, keywords in documents, data, or elements; and
rank at least a portion of the plurality of different entities based on both the number of times the one or more words were used in the recordings and the weight information.

22. A method, comprising:
storing, by a computing system, for each of a plurality of different entities, one or more recordings that include either in data (structured or unstructured), documents, audio, and video data or vice versa;
generating, by the computing system, a transcript of audio data from each of the recordings;
receiving, by the computing system, multiple sets of information, each set specifying one or more words;
determining, by the computing system, one or more locations in which words in ones of the sets were used in the one or more transcripts, data, or documents;
performing, by the computing system, facial recognition using the video data to determine facial attributes of a speaker at different times in the video data corresponding to ones of the one or more locations in the one or more transcripts;
performing by the computing system, audio analysis using the audio data to determine vocal attributes of a speaker at different times in the audio data corresponding to ones of the one or more locations in the one or more transcripts;
determining and storing, by the computing system, weight information for occurrences of words in ones of the sets based on the determined facial attributes, vocal attributes, keywords in documents, data, or elements; and
ranking, by the computing system, at least a portion of the plurality of different entities based on both the number of times the one or more words were used in the recordings and the weight information.

23. A non-transitory computer-readable medium having instructions stored thereon that are executable by a computing device to perform operations comprising:
store for each of a plurality of different entities, one or more recordings that include either in data (structured or unstructured), documents, audio, and video data or vice versa;
generate a transcript of audio data from each of the recordings;
receive multiple sets of information, each set specifying one or more words;
determine one or more locations in which words in ones of the sets were used in the one or more transcripts, data, or documents;
perform facial recognition using the video data to determine facial attributes of a speaker at different times in the video data corresponding to ones of the one or more locations in the one or more transcripts;
performing by the computing system, audio analysis using the audio data to determine vocal attributes of a speaker at different times in the audio data corresponding to ones of the one or more locations in the one or more transcripts;
determine and store weight information for occurrences of words in ones of the sets based on the determined facial attributes, vocal attributes, keywords in documents, data, or elements; and
rank at least a portion of the plurality of different entities based on both the number of times the one or more words were used in the recordings and the weight information.
